(19) United States
(12) Patent Application Publication
(10) Pub. No.: US 2007/0086614 A1
(43) Pub. Date: Apr. 19, 2007

(54) ELECTRONIC APPARATUS WITH SPEAKER

(75) Inventors: Takeshi Ikeda, Ohta-ku, Tokyo (JP); Akira Okamoto, Ageo-shi, (JP)

Correspondence Address: CONNOLLY BOVE LODGE & HUTZ LLP, P.O. BOX 2207, WILMINGTON, DE, 19899-2207, US

(73) Assignee: NIIGATA SEIMITSU CO., LTD., Jyoetsu-shi (JP)

(21) Appl. No.: 11/611,213

(22) Filed: Dec. 15, 2006

Related U.S. Application Data
(63) Continuation of application No. PCT/JP05/00713, filed on Jan. 14, 2005.

(30) Foreign Application Priority Data
Jun. 21, 2004 (JP) 2004-182084

(51) Int. Cl. H04R 1/02; H04R 9/06

(52) U.S. Cl. 381/334; 381/386

(57) ABSTRACT

An electronic apparatus comprising a speaker section 2 for outputting sound from a sound radiating section 2a, box section 3 comprising a space capable of containing the speaker section 2, box guide section 4 for coupling an electronic apparatus body 1 with the box section 3 and for guiding movement of the box section 3 so that sound is outputted toward the space in the box section 3 from the sound radiating section 2a when the box section 3 is moved by the box guide section 4 from a state containing the speaker section 2 to a state exposing the speaker section 2 at the time of outputting sound from the speaker section 2. Users can listen to adequate quality sound even with the minimized speaker section 2 because the adequate quality sound produced from the sound outputted from the sound radiating section 2a in the speaker section 2 and the sound resonated in the space of the box section 3 can be outputted.

### CROSS REFERENCE TO RELATED APPLICATIONS

This application is a Continuation under 35 USC 120 of International Application PCT/JP2005/000713 filed on Jan. 14, 2005. International Application PCT/JP2005/000713 claims priority to Japanese Application 2004-182084 filed on Jun. 21, 2004. The entire contents of each of these applications are incorporated herein by reference.

### BACKGROUND

This disclosure relates to a electronic apparatus with speaker wherein a speaker for outputting a sound signal from the electronic apparatus to the outside is equipped.

Conventionally, speaker-equipped electronic apparatuses such as radios, radio cassette players, and CD systems have been minimized. The minimized electronic apparatuses can be easily carried out and placed in a narrow space in the room and the like.

A speaker-equipped electronic apparatus wherein a hinge and the like are used to a body section of the electronic apparatus for rotatably supporting a speaker section has been known (see, for example, Japanese Patent Application Laid-open No. 2002-261462).

With conventional technologies such as the above, however, it is impossible to obtain adequate sound quality because the speaker section is minimized as well as the electronic apparatus body.

### SUMMARY

This disclosure is useful to solve the above-mentioned problem and has an object to obtain adequate quality in sound outputted from an electronic apparatus while minimizing the electronic apparatus including a speaker section.

In order to solve the above-mentioned problem, an embodiment of this disclosure comprises a speaker section for converting a sound signal reproduced from an electronic apparatus body to sound to be outputted from a sound radiating section, box section provided with a space capable of containing the speaker section for covering the speaker section, and box guide section for coupling the electronic apparatus body with the box section and for guiding movement of the box section so that sound is outputted from the sound radiating section in the speaker toward the space in the box section when the box section is moved along the box guide section from a state containing the speaker section to a state exposing the speaker section at the time of outputting sound from the speaker radiating section in the speaker section.

In another aspect of the this disclosure, the speaker section together with a box section forms a single space. And the box section comprises an opening section at the position opposed to a sound radiating section in the speaker under a state that a speaker section is contained in a box section.

According to the electronic apparatus with speaker having the above-mentioned configuration, users can listen to sound with adequate quality even though the speaker section is small due to the minimized electronic apparatus. The reason is that the adequate quality sound produced by sound outputted from the sound radiating section in the speaker and sound resonated in the space of the box section can be outputted since the sound outputted from the sound radiating section in the speaker is resonated in the space of the box section created by movement of the box section.

According to another aspect of this disclosure, even though a speaker section is contained in a box section, sound from a sound radiating section in a speaker section can be outputted to the certain degree because an opening section is provided in a box section. With the electronic apparatus having such configuration, users can listen to sound with adequate quality even though the speaker section is small due to the minimized electronic apparatus. The reason is that the adequate quality sound produced by sound outputted from the front of the sound radiating section in the speaker section and sound outputted from the opening section in the box section can be outputted since the opening section provided in the box section functions as a bass-reflex port for outputting the sound outputted from the back side of the sound radiating section to the space of the speaker.

### BRIEF DESCRIPTION OF THE DRAWINGS

FIGS. 1A and 1B are diagrams showing a configuration example of a electronic apparatus with speaker according to this disclosure.

FIGS. 2A and 2B are diagrams showing a electronic apparatus with speaker in use according to an embodiment.

FIGS. 3A and 3B are diagrams showing a modulated example of a electronic apparatus with speaker according to an embodiment.

FIGS. 4A and 4B are diagrams showing a modulated example of a electronic apparatus with speaker in use according to an embodiment.

### DETAILED DESCRIPTION

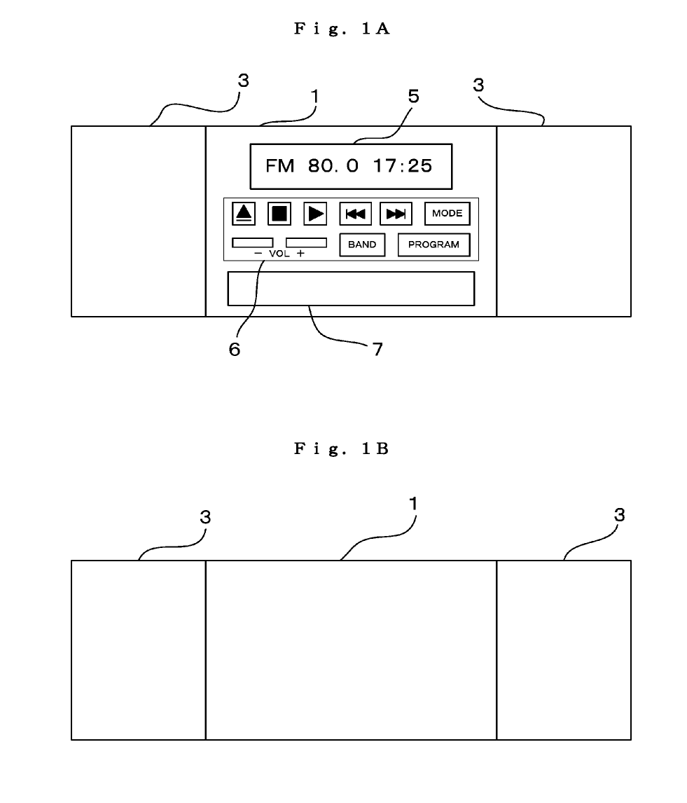

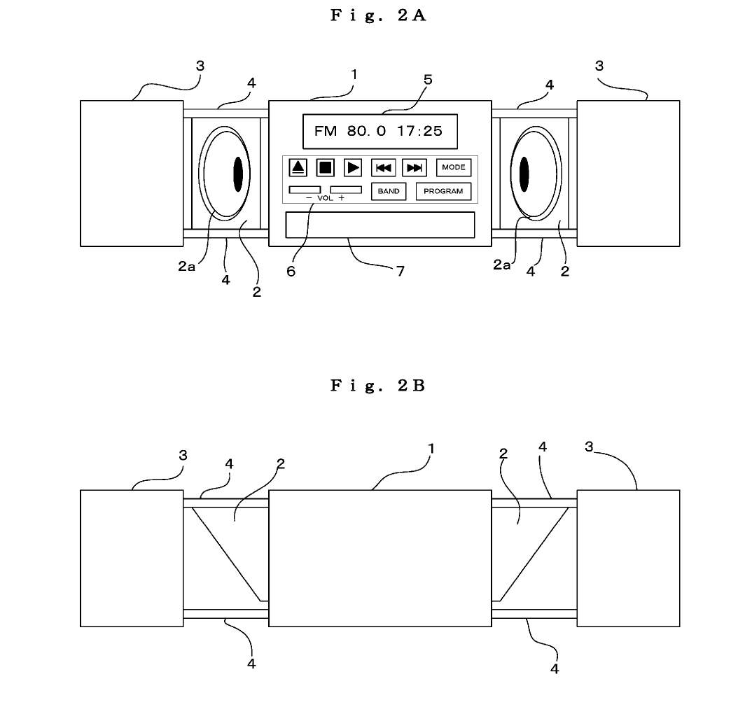

The embodiments of this disclosure will be explained referring to drawings. FIG. 1 is a diagram showing a configuration example of a electronic apparatus with speaker (speaker-equipped electronic apparatus) according to an embodiment, FIG. 1A is a front view of the speaker-equipped electronic apparatus according to an embodiment, and FIG. 1B is a plan view of the speaker-equipped electronic apparatus according to an embodiment. FIG. 2 is a diagram showing a speaker-equipped electronic apparatus in use according to an embodiment, FIG. 2A is a front view of the speaker-equipped electronic apparatus according to an embodiment, and FIG. 2B is a plan view of the speaker-embedded electronic apparatus according to an embodiment.

In FIGS. 1 and 2, an electronic apparatus body denoted with 1 comprises a tuner for receiving radio broadcasting, disc reproduction device for reproducing a disc such as CD, clock for obtaining present time information and the like. A speaker section denoted with 2 converts a sound signal of radio broadcasting received in the electronic apparatus body 1 and a sound signal of reproduced disc and the like to sound to be outputted from a sound radiating section 2a. The obverse side of each sound radiating sections 2a is placed leaning to right direction or left direction.

The box section denoted with 3 contains a space wherein the electronic apparatus body 1 side is open. Also, the box section 3 is capable of containing the speaker section 2. A box guide section denoted with 4 comprises metallic stick materials provided by four to right side and left side of the electronic apparatus body 1.

The box guide section 4 couples the electronic apparatus body 1 with box section 3 and guides the box section 3 so as to expose the speaker section 2 contained in the space of the box section 3. Locking materials (not shown) are provided to the box guide section 4 so as not to separate the box section 3 from the electronic apparatus body 1 more than a prescribed distance. The metallic stick material constituting each box guide section 4 is an antenna such as a rod antenna and functions as an antenna when receiving radio broadcasting in the electronic apparatus body 1.

A display section denoted with 5 displays a type of band, reception frequency, and the like of the radio broadcasting when the radio broadcasting is received in the electronic apparatus body 1 and displays a track number under reproduction, reproduction time, and the like when a disc such as a CD is reproduced. Also, the display section 5 displays the present time according to the present time information obtained from the clock embedded in the electronic apparatus body 1.

An operation section denoted with 6 comprises buttons arranged for performing operation such as switchover between radio broadcasting and disc reproduction, switchover of radio broadcasting band, switchover of a reception frequency of radio broadcasting, reproduction of a disc, skip of a track under reproduction, stop of a disc, and adjustment of volume. A disc tray denoted with 7 is a tray for inserting a disc such as a CD into the electronic apparatus body 1.

In the speaker-equipped electronic apparatus according to an embodiment having such configurations, although sound can be outputted from the sound radiating section 2a in the speaker section 2 even under the situation shown in FIG. 1, the sound outputted from the electronic apparatus has low volume and poor quality because the speaker section 2 is covered with the box section 3. To obtain adequate sound, the speaker section 2 is exposed by moving each box section 3 in the right and left according to the box guide section 4 as shown in FIG. 2. Since the obverse sides of each sound radiating section 2a in the speaker section 2 are placed leaning to right direction and left direction i.e. facing the space in the box section 3, the sound outputted from the sound radiating section 2a is outputted through the space in the box section 3 to the front of the electronic apparatus body 1.

As mentioned in details, the speaker-equipped electronic apparatus of an embodiment comprises the speaker section 2 for converting a sound signal from the electronic apparatus body 1 to sound to be outputted from the sound radiating section 2a, box section 3 comprising a space capable of containing the speaker section 2 for covering the speaker section 2, and box guide section 4 for coupling the electronic apparatus body 1 with box section 3 and for guiding movement of the box section 3 so that sound is outputted from the sound radiating section 2a toward the space in the box section 3 to be resonated in the space of the box section 3 when the box section 3 is moved along the box guide section 4 from a state containing the speaker section 2 to a state exposing the speaker section 2 at the time of outputting sound from the speaker section 2. Therefore, even with the small speaker section 2 due to the minimized electronic apparatus, users can listen to adequate quality sound because the adequate quality sound produced by the sound outputted from the sound radiating section 2a and sound resonated in the space in the box section 3 can be outputted.

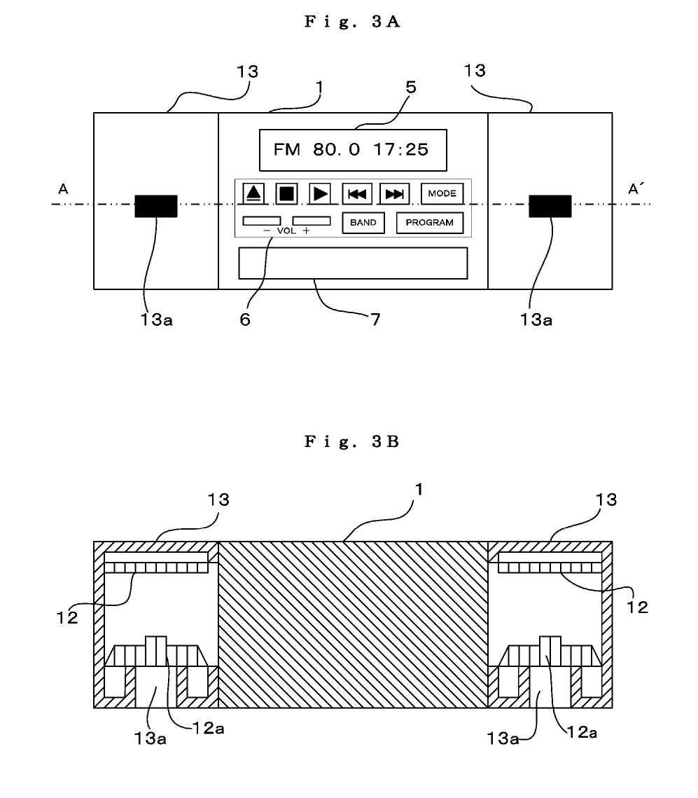

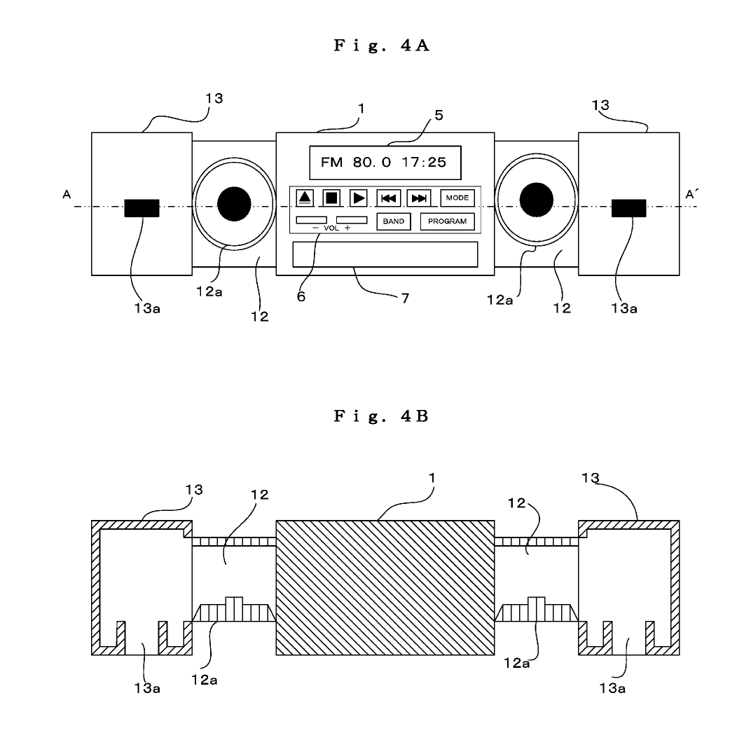

In the above-mentioned embodiment of the disclosure, although the sound outputted from the obverse sides of each sound radiating section 2a in the speaker section 2 is resonated in the space of the box section 3, this is not limiting this disclosure. For example, as shown in FIGS. 3 and 4, the electronic apparatus may comprise a speaker section 12 and box section 13 so as to form a single space and also comprise an opening section 13a at a position opposed to the obverse side of a sound radiating section 12a in the box section 13.

FIG. 3 is a diagram showing a modulated example of a speaker-equipped electronic apparatus according to an embodiment, FIG. 3A is a front view of the modulated example of the speaker-equipped electronic apparatus, and FIG. 3B is a cross-sectional view along the line A-A′ of the modulated example of the speaker-equipped electronic apparatus.

FIG. 4 is a diagram showing a modulated example of a speaker-equipped electronic apparatus in use according to an embodiment, FIG. 4A is a front view of the modulated example of the speaker-equipped electronic apparatus, and FIG. 4B is a cross-sectional view along the line A-A′ of the modulated example of the speaker-equipped electronic apparatus.

According to the modulated example of the speaker-equipped electronic apparatus having such configuration, sound can be outputted to some extent from the obverse sides of each sound radiating section 12a in the speaker section 12 through the opening section 13a provided in the box section 13 even in the sate containing the speaker section 12 in the box section 13.

In the case that each box section 13 is moved to right side and left side, the opening section 13a provided in the box section 13 functions as a bass-reflex port for outputting sound which is outputted from the reverse side of the sound radiating section 12a to the space of the speaker section 12. Thus, users can listen to adequate quality sound even with the small speaker section 12 due to the minimized electronic apparatus. The reason is that the adequate quality sound, produced by sound outputted from the obverse sides of each sound radiating section 12a in the speaker section 12 and sound outputted from the opening section 13a through the reverse side of the sound radiating section 12a in the speaker section 12, can be outputted.

Although movement of the box section 3 is performed manually in this embodiment, movement of the box section 3 may be performed electronically. In this instance, the box section 3 may be moved automatically so that the speaker section 2 is exposed from the box section 3 when the present time is judged in the prescribed range (a period of time excepting midnight and early morning, for example) based on the present time information obtained from the clock embedded in the electronic apparatus body 1. This can prevent the large-volume sound from being outputted during midnight, early morning, and the like because the sound radiating section 2a in the speaker section 2 is covered with the box section 3.

Besides, although eight stick materials constituting the box guide section 4 are used as antennas in this embodiment, the antennas in a preferable receiving state may be selectively used among the eight antennas.

Moreover, the above-described embodiments are not more than specific examples in implementing this disclosure and these should not be interpreted as restricting the technological scope of this disclosure. That is, teachings of this disclosure may be embodied in other specific forms without departing from the spirit or essential characteristic thereof.

### INDUSTRIAL APPLICABILITY

An apparatus of this disclosure is useful for an electronic apparatus equipped with a small speaker.

What is claimed as new and desired to be protected by Letters Patent of the United States is:

1. A electronic apparatus with speaker, comprising:
an electronic apparatus body for reproducing a sound signal;
speaker section for converting the sound signal reproduced from said electronic apparatus body to sound to be outputted from a sound radiation section;
box section provided with a space capable of containing said speaker section for covering the said speaker section; and
box guide section for coupling said electronic apparatus body with said box section and for guiding movement of said box section;
so that sound is outputted from said speaker section toward the space in said box section when said box section is moved by said box guide section from a state covering said speaker section to a state exposing said speaker section at the time of outputting sound from said speaker section.

2. The electronic apparatus with speaker according to claim 1,
the sound radiating section of said speaker section faces the space in said box section.

3. The electronic apparatus with speaker according to claim 1,
said electronic apparatus body comprises a radio receiver; and
said box guide section is an antenna for receiving radio broadcasting in said electronic apparatus body.

4. The electronic apparatus with speaker according to claim 3,
wherein a plurality of said antennas exist; and
said electronic apparatus body selectively uses the antenna which preferably receives said radio broadcasting among a plurality of said antennas.

5. A electronic apparatus with speaker, comprising:
an electronic apparatus body for reproducing a sound signal;
speaker section for converting the sound signal reproduced from said electronic apparatus body to sound to be outputted from a sound radiating section; and
box section having a space capable of containing said speaker section for covering said speaker section, being movable from a state containing said speaker section to a state exposing said speaker section, and comprising an opening section at the position opposed to the sound radiating section of said speaker section under the state containing said speaker section;
wherein said speaker section together with said box section forms a single space when said box section is moved from a state covering said speaker section to a state exposing said speaker section; and
sound is outputted from the obverse side of said speaker section to outside of said space, and sound outputted from the reverse side of said speaker section to said space in said speaker section is outputted from the opening section provided in said box section.
